(19) United States
(12) Patent Application Publication
(10) Pub. No.: US 2020/0281792 A1
(43) Pub. Date: Sep. 10, 2020

(54) Vibration device and body stimulation method using same

(71) Applicant: ATEX CO., LTD., Osaka-shi (JP)

(72) Inventors: Masaki ISHIKAWA, Osaka (JP); Akitoshi MAKINO, Osaka (JP); Satoshi OUCHI, Osaka-shi (JP)

(21) Appl. No.: 16/798,677

(22) Filed: Feb. 24, 2020

(30) Foreign Application Priority Data
Mar. 5, 2019 (JP) 2019-039241

(51) Int. Cl. A61H 1/00

(52) U.S. Cl. CPC A61H 1/005; A61H 2201/1676; A61H 2203/0406; A61H 2201/1652

(57) ABSTRACT

A vibration device for applying a vibration stimulus to a user, comprises: a base, a platform supported by the base and on which the user gets, a vibrator for the platform, and a belt connected to the platform. A body stimulation method comprises: using the vibration device and vibrating the platform under such a condition that the user gets on the platform and pulls the platform with the belt.

### TECHNICAL FIELD

The present invention relates to a vibration device for applying a vibration stimulus to a user, and a method of stimulating the body by the use of the vibration device.

### BACKGROUND ART

Patent document 1 listed below discloses a vibration healthcare equipment which is used by a user with both feet placed on a footrest. The vibration healthcare equipment of Patent document 1 is intended to cause stimulation of the lower body of the user as well as an appropriate exercise effect on the entire body of the user by applying fast vibration to the user.

Patent document 1: Japanese Patent Application Publication No. 2008-029712

### SUMMARY OF THE INVENTION

### Problems to be Resolved by the Invention

The vibration healthcare equipment of Patent document 1 has been demanded to be further improved so as to be able to apply the vibration strongly to a wide range of a user's body.

The present invention has been devised in view of the above situation, and an object of the present invention is to provide a vibration device and a body stimulating method which can strongly apply vibration to a wide range of a user's body, and thus the user can obtain an excellent exercise effect.

According to a first aspect of the present invention, a vibration device for applying a vibration stimulus to a user, comprises: a base, a platform supported by the base and on which the user gets, a vibrator for vibrating the platform, and a non or less-stretchable belt connected to the platform.

In the vibration device, it is preferable that both end portions of the belt are connected to the platform.

In the vibration device, it is preferable that the belt comprises a first portion having a first end connected to the platform, a second portion having a second end connected to the platform, and a connector detachably connecting the first portion to the second portion.

In the vibration device, it is preferable that each of the first portion and the second portion is adjustable in length.

In the vibration device, it is preferable that the length of the belt can be adjusted from 1.0 m to 4.0 m.

In the vibration device, it is preferable that, in a top view of the platform, the platform has a dimension in a lateral direction and a dimension in a perpendicular direction to the lateral direction, wherein the dimension in the lateral direction is not more than 1.1 times the dimension in the perpendicular direction, and

the vibrator vibrates the platform by seesawing the platform with a center of the platform between both ends of the platform in the lateral direction as a fulcrum of seesaw so that the above-said both ends move up and down alternately.

In the vibration device, it is preferable that the platform has an upper surface and side surfaces connected to the upper surface, wherein the side surfaces include two first side surfaces extending in the lateral direction, and two second side surfaces extending in the perpendicular direction, and

the belt is connected to the second side surfaces.

According to a second aspect of the present invention, a body stimulation method comprises:

using the vibration device for applying a vibration stimulus to a user, the vibration device comprising the base, the platform supported by the base and on which the user gets, the vibrator for vibrating the platform, and the non or less-stretchable belt connected to the platform, and

vibrating the platform under such a condition that the user gets on the platform and pulls the platform with the belt.

In the body stimulation method, it is preferable to vibrate the platform under such a condition that the user hangs the belt on his/her shoulder while the both ends of the belt are connected to the platform.

In the body stimulation method, it is preferable to vibrate the platform by seesawing the platform with a center of the platform between both ends of the platform in the lateral direction as a fulcrum of seesaw so that the above-said both ends move up and down alternately under such a condition that the user gets on the platform, straddling the center of the platform, with the shoulder width direction of the user corresponding to the lateral direction.

In the body stimulation method, it is preferable to vibrate the platform by seesawing the platform with a center of the platform between both ends of the platform in the lateral direction as a fulcrum of seesaw so that the above-said both ends move up and down alternately under such a condition that the user gets on the platform, aligning the both feet, while the both feet are positioned on the center of the platform, orienting the toes of the both feet toward one side in the lateral direction.

In the vibration device according to the present invention, the belt is connected to the platform which is vibrated. In the body stimulation method according to the present invention, the platform is vibrated under such a condition that the user gets on the platform and pulls the platform with the belt.

Therefore, the vibration of the platform is transmitted to the user via a direct contact between the platform and the feet of the user as well as through the belt. As a result, a wide range of the user's body can be applied by strong vibration, and it is possible for the user to obtain an excellent exercise effect.

### BRIEF DESCRIPTION OF THE DRAWINGS

FIG. 1 is a perspective view of a vibration device as an embodiment of the present invention.

FIG. 2 is a perspective view showing the internal structure of the vibration device shown in FIG. 1.

FIG. 3 is a diagram for explaining a body stimulation method as an embodiment of the present invention which uses the vibration device shown in FIG. 1.

FIG. 4 is a top view of the vibration device shown in FIG. 1.

FIG. 5 is a top view of a vibration device as another embodiment of the present invention.

FIG. 6 is a top view of a vibration device as still another embodiment of the present invention.

FIG. 7 shows a first portion and a second portion of the belt.

FIG. 8 is a diagram for explaining a body stimulation method as another embodiment of the present invention.

FIG. 9 is a diagram for explaining a body stimulation method as still another embodiment of the present invention.

FIG. 10 is a diagram for explaining a body stimulation method as yet still another embodiment of the present invention.

### DESCRIPTION OF THE PREFERRED EMBODIMENTS

Embodiments of the present invention will now be described in detail in conjunction with the accompanying drawings.

A first aspect of the present invention is a vibration device for applying a vibration stimulus to a user.

A second aspect of the present invention is a body stimulation method using the vibration device.

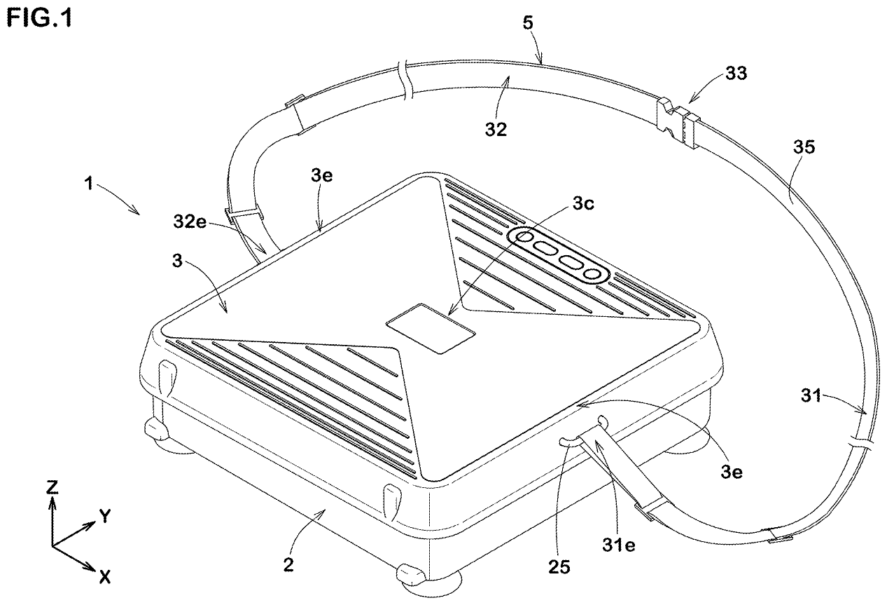

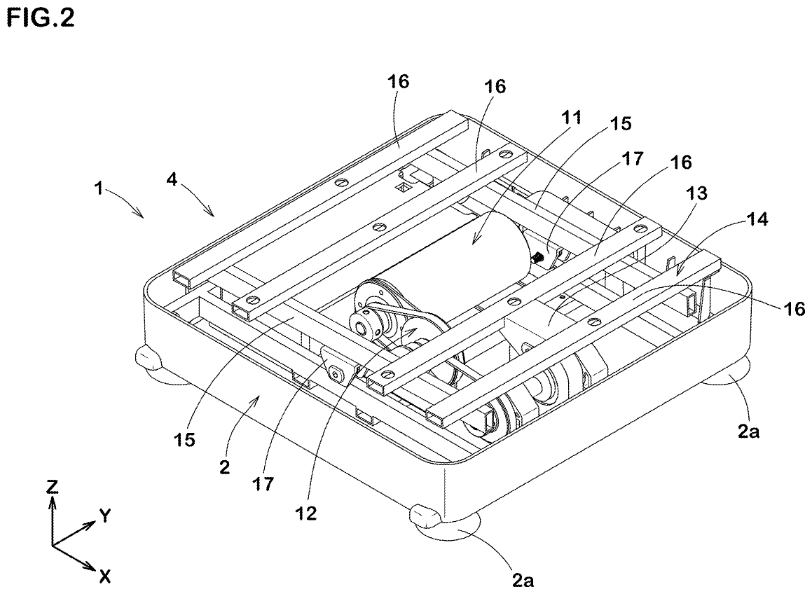

FIG. 1 shows a vibration device 1 as an embodiment of the present invention. FIG. 2 shows the internal structure of the vibration device 1.

In this specification, x direction, Y direction and z direction shown in the drawings may be referred to as the lateral direction, perpendicular direction and height direction, respectively.

As shown in FIGS. 1 and 2, the vibration device 1 comprises a base 2, a platform 3 supported by the base 2 and on which a user gets, and a vibrator 4 for vibrating the platform 3.

In the vibration device 1 according to the present invention, a non or less-stretchable belt 5 is connected to the platform 3.

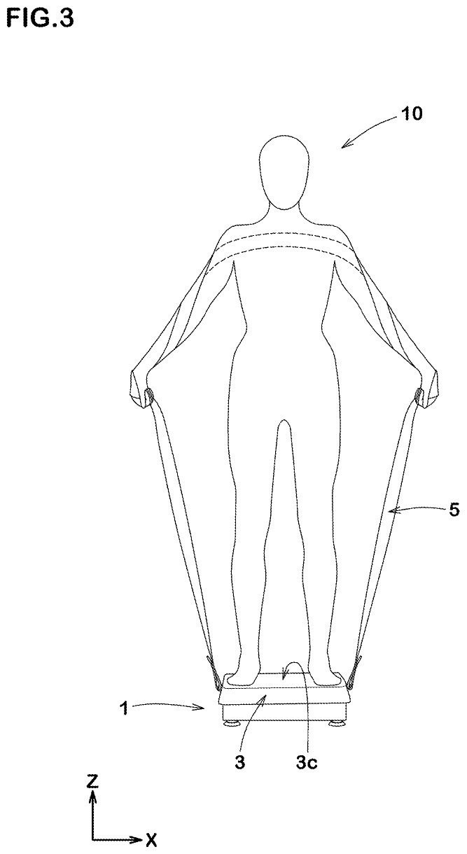

FIG. 3 shows an embodiment of the body stimulation method using the vibration device 1 according to the present invention.

In the body stimulation method according to the present invention, the platform 3 is vibrated by the vibrator 4 under such a condition that the user 10 is on the platform 3 and pulls the platform 5 with the belt 5 as shown in FIG. 3.

In the vibration device 1 and the body stimulation method according to the present invention, the vibration of the platform 3 can be transmitted to the user not only via the direct contact between the platform 3 and the feet of the user 10 but also through the belt 5. Therefore, a wide range of the body of the user 10 can be applied by strong vibration.

Thus, it is possible for the user to obtain an excellent exercise effect therefrom.

As shown in FIG. 2, the base 2 in this example is rectangular in its top view. And, the base 2 is formed in the form of a box so as to accommodate the vibrator 4 therein. In order to support the vibration device 1, the base 2 is provided with leg portions 2a for contacting with the floor surface, for example, positioned at four corners of the bottom surface of the base 2.

The vibrator 4 in this embodiment is configured to vibrate the platform 3 by alternately raising and lowering both ends 3e of the platform 3 in its lateral direction (X direction) by seesawing the platform 3 with its center 3c (shown in FIG. 1) between the both ends 3e as a fulcrum of seesaw motion (hereinafter, such motion may be referred to as the “seesaw-like vibration mode”).

In the present invention, however, the vibrator 4 is not limited to the seesaw-like vibration mode. It is possible to employ various vibration modes, for example:

a vertical vibration mode in which the whole platform 3 is vibrated or moved in the height or vertical direction,
a horizontal vibration mode in which the whole platform 3 is vibrated or moved in the horizontal direction, and
a multiple vibration mode in which a vertical vibration mode and a horizontal vibration mode are mixed.

In this example, as shown in FIG. 2, the vibrator 4 comprises an electric motor 11, a transmission unit 12 which transmits the power of the electric motor 11, a drive part 13 which is moved up and down by the power of the electric motor 11, and a movable frame 14 linked with the drive part 13 and supporting the platform 3.

The transmission unit 12 in this example slows down the rotational movement of the electric motor 11 and converts the rotational movement into a vertical reciprocating movement using a crank or the like. Thereby, the drive part 13 is moved up and down.

The movable frame 14 in this example comprises a plurality of frames which include two lateral frames 15 extending in the lateral direction (X), and four perpendicular frames 16 extending in the perpendicular direction (Y). The four perpendicular frames 16 connect the two lateral frames 15.

In this example, each of the lateral frames 15 is supported at its center position in the lateral direction as a fulcrum 17 by a supporting point so that the lateral frames 15 can rotate or incline about the supporting points at the same time whereby the ends on one side in the lateral direction and the ends on the other side in the lateral direction of the lateral frames 15 can be alternately raised and lowered.

On one side in the lateral direction of the fulcrum 17, two of the four perpendicular frames 16 are disposed and connected to the lateral frames 15.

On the other side in the lateral direction of the fulcrum 17, other two perpendicular frames 16 are disposed and connected to the lateral frames 15.

Further, the two perpendicular frames 16 disposed on one side in the lateral direction of the fulcrum 17 are connected to the drive part 13 which is moved up and down as described above.

In the vibrator 4 having the above-described structure in this embodiment, by the operation of the electric motor 11, the drive part 13 is moved up and down, and the movable frame 14 linked to the drive part 13 is seesawed, therefore, the platform 3 supported by the movable frame 14 can be vibrated in the seesaw-like vibration mode.

In the present invention, however, the vibrator 4 is not limited to the above-described structure. The need is to be able to vibrate the platform 3.

In the vibrator 4 in this embodiment, the rotation speed of the electric motor 11 is adjustable so that the number of cycles of the vibration can be varied from 420 to 630 per minute, preferably from 200 to 800 per minute, for example.

Further, it is preferable for the vibrator 4 that the user can arbitrarily select the number of rotations of the electric motor 11 so as to adjust the intensity of the vibration the user feels. For example, the vibrator 4 is configured such that the intensity (cycles) of the vibration of the platform 3 can be set to nine levels, and the user can select a desired intensity level therefrom.

Further, it is preferable that the user can select the intensity of the vibration during using the vibration device 1, for example, by using a wireless remote controller (not shown).

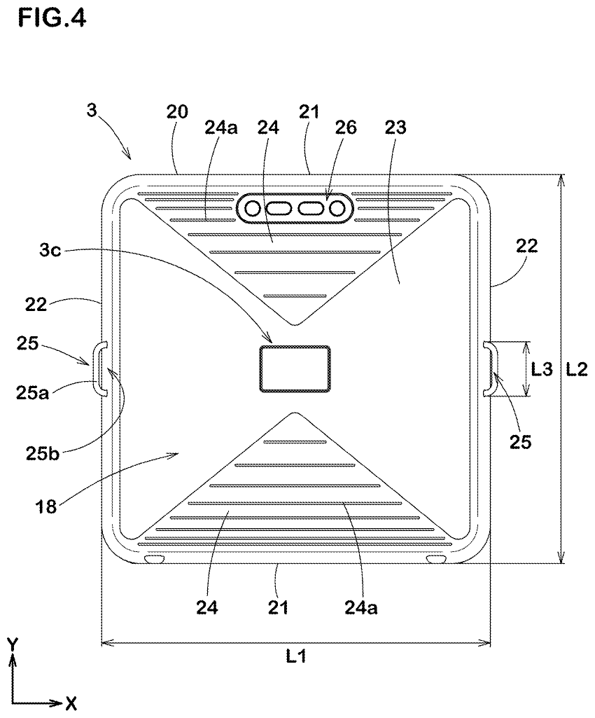

FIG. 4 is a top view of the vibration device 1.

As shown in FIG. 4, the platform 3 in the present embodiment has an upper surface 18 and side surfaces 20 connected to the upper surface 18. The side surfaces 20 include two first side surfaces 21 extending in the lateral direction (X), and two second side surfaces 22 extending in the perpendicular direction (Y).

The platform 3 in the present embodiment is provided on the side surfaces 20 with connection fittings 25 used to connect the belt 5 to the platform 3.

The platform 3 in this example has a rectangular shape when viewed from above. The dimension L1 in the lateral direction and the dimension L2 in the perpendicular direction of the platform 3 are, for example, set in a range from 300 to 550 mm, preferably from 400 to 450 mm.

Such platform 3 is large enough for the user to stand with both feet on its upper surface 18.

The respective dimensions L1 and L2 of the platform 3 do not include the connection fittings 25.

It is preferable that the dimension L1 in the lateral direction is not more than 1.1 times the dimension L2 in the perpendicular direction. More preferably, the dimension L1 is not less than 0.95 time, but not more than 1.05 times the dimension L2.

In such platform 3, since the dimension L1 in the lateral direction is smaller than that of the conventional one, a large load does not act on the vibrator 4 even when both feet are positioned at very both ends of the upper surface 18 in the lateral direction. Therefore, in the vibration device 1 in the present embodiment, the electric motor 11 can be prevented from stopping due to overload.

In the present embodiment, the upper surface 18 of the platform 3 includes a first tread surface 23 which is a smooth or matte surface, and a second tread surface 24 provided with a plurality of ridges 24a extending in the lateral direction.

The first tread surface 23 in this example is gradually decreased in its length in the perpendicular direction from the two second side surfaces 22 toward the center 3c in the lateral direction.

The second tread surface 24 in this example is gradually decreased in its length in the lateral direction from the two first side surfaces 21 toward the center 3c in the perpendicular direction.

For example, in the second tread surface 24, a switch panel 26 including a power switch and the like of the vibration device 1 is arranged.

The upper surface 18 of the platform 3 is however, not limited to such example.

In the present embodiment, each of the connection fittings 25 is a u-shaped fitting 25a of which both ends are connected to one of the side surfaces 20 to form a closed loop 25b in this example.

Each end portion of the belt 5 passes through the loop 25b and thereby the belt 5 is connected to the platform 3.

For example, the length L3 of each of the connection fittings 25 measured along the side surface 20 in the top view of the platform 3 is set in a range from 0.05 to 0.30 times the dimension L2 of the platform 3 in the perpendicular direction.

In the present embodiment, each of the second side surfaces 22 is provided with one connection fitting 25 positioned in a central portion in the perpendicular direction of the second side surface 22.

Thus, the both ends of the belt 5 are connected to the platform 3 on both sides thereof in the lateral direction.

The arrangement of the connection fittings 25 is not limited to the above-described example.

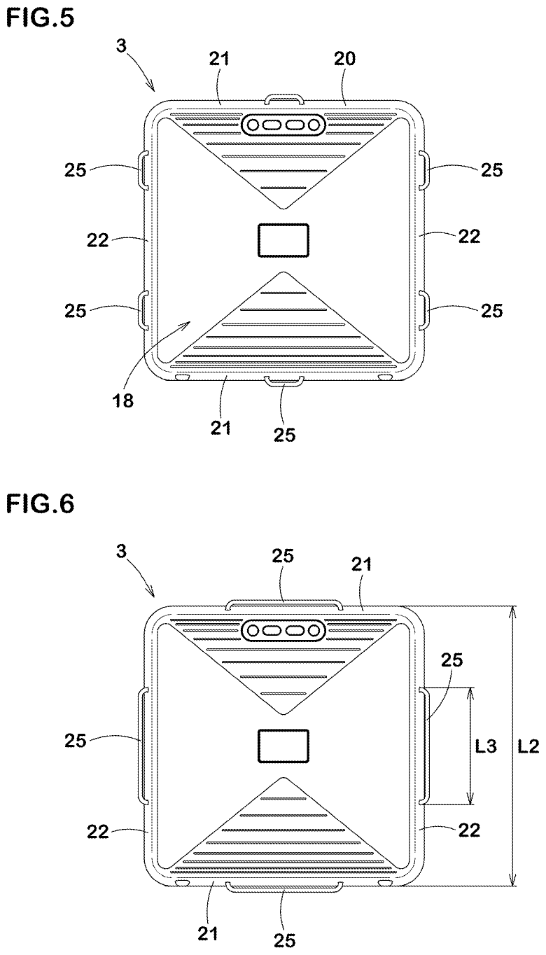

FIGS. 5 and 6 each show another example of the arrangement of the connection fittings 25.

As shown in FIG. 5, two or more connection fittings 25 may be provided on each of the second side surface 22.

Further, as shown in FIG. 5, one or more connection fittings 25 may be provided on each of the first side surfaces 21. With such arrangements of the connection fittings 25, the belt 5 can be connected to the various positions (connection fittings) of the platform 3, therefore, the vibration device 1 can be used in order to obtain a higher or more effective exercise effect.

As shown in FIG. 6, it is possible to use a longer connection fitting 25 whose length L3 measured along the side surface 20 is, for example, in a range from 0.30 to 0.60 times the dimension of the side surface 20.

Such longer connection fitting 25 may be provided on each of the side surfaces 20.

The non or less-stretchable belt 5 has to have strength capable of transmitting the vibration of the platform 3 to the user. For this reason, the belt 5 is preferably formed from a nylon belt 35 whose width is, for example, 15 to 50 mm.

Here, the expression “non or less-stretchable belt” means that the length of the belt when the belt is applied by a tension load of 10 kg (herein after the loaded state length) is not more than 1.20 times the length of the belt when applied by no tension load (herein after the unloaded state length).

In the belt 5 in this example, it is preferable that the loaded state length is not more than 1.10 times, more preferably not more than 1.05 times the unloaded state length.

It is preferable that both ends 31e and 32e of the belt 5 are respectively connected to the two connection fittings 25 of the platform 3.

It is preferable that the belt 5 comprises a first portion 31 including the first end 31e connected to the platform 3, a second portion 32 including the second end 32e connected to the platform 3, and a connector 33 for detachably connecting the first portion 31 with the second portion 32.

Thereby, such belt 5 is compatible with both use in a state where the first portion 31 and the second portion 32 are connected, and use in a state where the first portion 31 and the second portion 32 are separated.

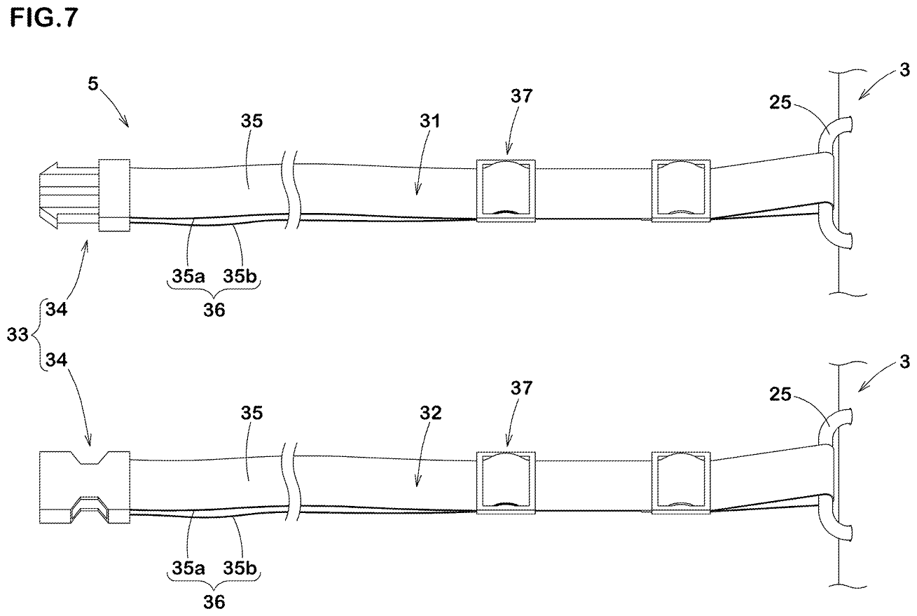

FIG. 7 shows the first portion 31 and the second portion 32. It is preferable that the length of each of the first portion 31 and the second portion 32 is adjustable.

More specifically, in a state where the first portion 31 and the second portion 32 are connected by the connector 33, the length of the belt 5 from one to the other of the connection fittings is adjustable from 2.0 m to 3.6 m, preferably from 1.0 to 4.0 m, for example.

In the belt 5 in this example, the connector 33 is composed of a pair of first and second buckles 34, and the nylon belt 35 of the first portion 31 is folded back through a loop of the first buckle 34 and the folded-back end thereof is fastened by a first fastener 37, and also the nylon belt 35 of the second portion 32 is folded back through a loop of the second buckle 34 and the folded-back end thereof is fastened by a second fastener 37.

Thereby, each of the first portion 31 and the second portion 32 has a doubled part 36 in which the folded back part 35b of the nylon belt 35 overlaps with the main part 35a of the nylon belt 35. In this example, therefore, by adjusting the length of the doubled part 36 between the first/second buckle 34 and the first/second fastener 37, the length of the first portion 31 and the length of the second portion 32 can be adjusted separately.

In the body stimulation method using the vibration device 1 described above, it is preferable to vibrate the platform 3 in such a condition that the user wears the belt 5 on the shoulder or the back as shown in FIG. 3.

Such method can provide a high exercise effect for the whole body of the user.

Specifically, in this physical stimulation method, high exercise effects can be expected for muscles of thigh such as lateral great muscle and rectus femoris, back muscles such as latissimus dorsi and erector spinae, and upper limb muscles such as trapezius and biceps.

In the body stimulation method, it is more preferable that the user 10 spirally winds the belt 5 around both arms and pulls the belt 5 with both hands upwardly and outwardly in the user's shoulder width direction as shown in FIG. 3. Thereby, the vibration of the platform 3 is effectively applied to the upper body of the user, and the above-described effect is further enhanced.

In the example shown in FIG. 3, the vibration of the platform 3 is performed in a first posture where the user 10 gets on the platform 3, straddling the center 3c of the platform 3 in the lateral direction, with the shoulder width direction of the user corresponding to the lateral direction.

In the first posture, both feet of the user are positioned on the platform's first tread surface 23 in this example (shown in FIG. 4).

Due to the seesaw vibration of the platform 3, the center of gravity of the user 10 standing in the first posture is swung mainly in the shoulder width direction (X direction in FIG. 3). In the first posture, even if the platform 3 swings, the user can easily balance with the muscles of both feet. Therefore, in the body stimulation method performed in the first posture, the user can continue using the device in a relatively stable state.

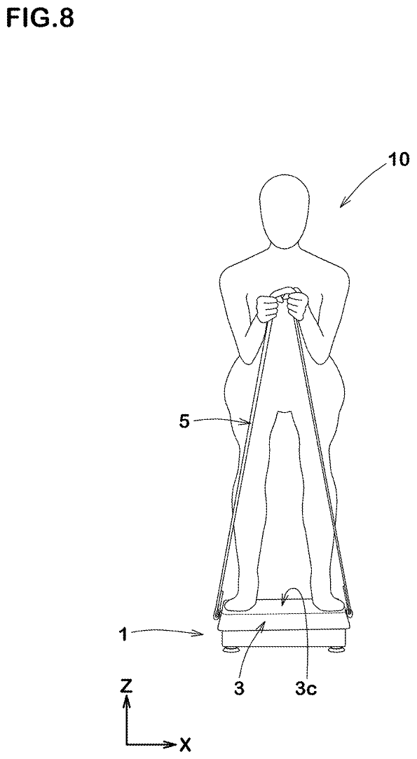

FIG. 8 shows another embodiment of the body stimulation method of the present invention. In this embodiment, the vibration of the platform 3 is performed under such a condition that the user 10 stands on the platform 3 in the above described first posture and then alters the posture to a semi-crouching position, grabbing one part of the belt 5 with both hands in front of the chest. This example of the physical stimulation method can exert a large load on the arms (biceps and triceps) and lower limbs (biceps femoris and vastus medialis muscle), among others.

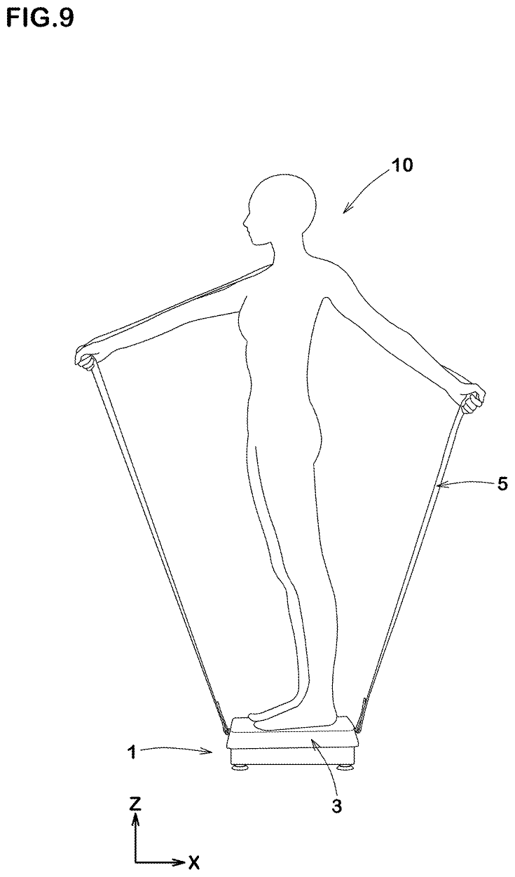

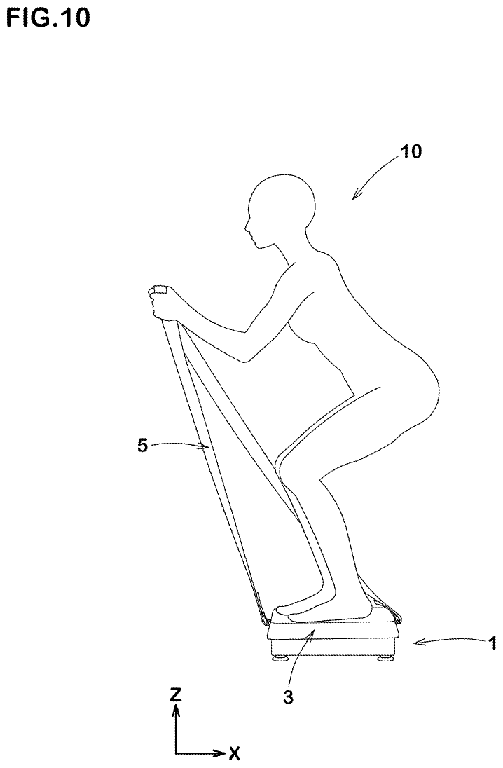

FIG. 9 shows still another embodiment of the body stimulation method of the present invention. In this embodiment, the vibration of the platform 3 is performed in a second posture where the user 10 gets on the platform 3, orienting the toes of both feet toward one side in the lateral direction, with both feet aligned at a center (3c) of the platform 3 in the lateral direction.

In this embodiment, the center of gravity of the user 10 is swung mainly in the front-rear direction of the user (X direction in FIG. 9) due to the seesaw vibration of the platform 3.

Therefore, it is necessary for the user in the second posture to balance the center of gravity under such seesaw vibration by using not only the lower body but also many muscles of the upper body since both feet are aligned. As a result, in the body stimulation method performed in the second posture, it is possible to apply a high load to the vastus lateralis muscle and trapezius muscle in particular. Thus, the user can obtaine a more excellent exercise effect over the whole body.

In the second posture, it is preferable that both feet of the user are positioned on the respective second tread surfaces 24 of the platform 3 (shown in FIG. 4).

The second tread surfaces 24 in this example are each provided with the ridges 24a extending in the lateral direction (X direction), therefore, a frictional force in the shoulder width direction of the user acts on both feet of the user. Thereby, the stability of the user in the second posture is improved.

In this embodiment, as shown in FIG. 9, the user 10 hangs the belt 5 on one shoulder, and pulls the belt 5 forward and backward with both hands respectively. Thereby, the vibration of the platform 3 is effectively applied to the upper body of the user.

FIG. 10 shows yet still another embodiment of the body stimulation method of the present invention. In this embodiment, the vibration of the platform 3 is performed under such a condition that the user 10 stands on the platform 3 in the above described second posture and then alters the posture to a semi-crouching position, grabbing one part of the belt 5 with both hands in front of the chest.

In this embodiment, it is possible to apply a large load on the calf muscles such as tibialis anterior muscle and internal gastrocnemius muscle, among others.

While detailed description has been made of preferable embodiments of the present invention, the present invention can be embodied in various forms without being limited to the illustrated embodiments.

### Comparison Test

The embodiments of the body stimulation method shown in FIG. 3 and FIG. 9 were performed using the vibration device 1 shown in FIG. 1.

As a comparative example, a body stimulating method was performed under such a condition that a user stands in the first posture on the platform of the vibration device 1 shown in FIG. 1 from which the belt was excluded.

In each of the embodiments according to the present invention and the comparative example, muscle activities of respective muscles of the user were measured by an electromyograph.

The results are indicated in Table 1 by an index based on the activity of each muscle when the user stood on the platform without vibrating the platform, being 1, wherein the larger the value, the more (the better) the muscle activity.

Incidentally, the vibration intensity of the vibrating device was the same for all of the embodiments according to the present invention and the comparative example.

TABLE 1

| | | Comparative | | |
|---|---|---|---|---|
| | | example | Embodiment 1 | Embodiment 2 |
| Figure showing Body stimulation method | | — | FIG. 3 | FIG. 9 |
| Back | Muscle activity of Latissimus dorsi (index) | 1 | 4 | 10 |
| | Muscle activity of Erector spinae (index) | 3 | 11 | 8 |
| Upper | Muscle activity of Trapezius muscle (index) | 1 | 40 | 80 |
| limb | Muscle activity of Biceps brachii (index) | 5 | 22 | 40 |
| | Muscle activity of Triceps brachii (index) | 1 | 8 | 17 |
| Thigh | Muscle activity of Lateral great muscle (index) | 10 | 80 | 90 |
| | Muscle activity of Medial great muscle (index) | 4 | 16 | 30 |

As shown in Table 1, it was confirmed that the vibration device and the body stimulating method according to the present invention exhibited an excellent exercise effect over the whole body of the user.

### REFERENCE SIGNS LIST

1 vibration device
2 base
3 platform
4 vibrator
5 belt
10 user

1. A vibration device for applying a vibration stimulus to a user, comprising: a base, a platform supported by the base and on which the user gets, a vibrator for vibrating the platform, and a non or less-stretchable belt connected to the platform.

2. The vibration device according to claim 1, wherein both end portions of the belt are connected to the platform.

3. The vibration device according to claim 2, wherein the belt comprises a first portion having a first end connected to the platform, a second portion having a second end connected to the platform, and a connector detachably connecting the first portion to the second portion.

4. The vibration device according to claim 3, wherein each of the first portion and the second portion is adjustable in length.

5. The vibration device according to claim 1, wherein the length of the belt is adjustable from 2.0 m to 3.6 m.

6. The vibration device according to claim 1, wherein, in a top view of the platform, the platform has a dimension in a lateral direction and a dimension in a perpendicular direction to the lateral direction, wherein the dimension in the lateral direction is not more than 1.1 times the dimension in the perpendicular direction, and
the vibrator vibrates the platform by seesawing the platform with a center of the platform between both ends of the platform in the lateral direction as a fulcrum of seesaw so that said both ends move up and down alternately.

7. The vibration device according to claim 6, wherein the platform has an upper surface and side surfaces, wherein the side surfaces include two first side surfaces extending in the lateral direction and two second side surfaces extending in the perpendicular direction, and
the belt is connected to the second side surfaces.

8. A body stimulation method comprising:
using the vibration device according to claim 1 which comprises the base, the platform supported by the base and on which the user gets, the vibrator for vibrating the platform, and the belt connected to the platform, and
vibrating the platform under such a condition that the user gets on the platform and pulls the platform with the belt.

9. The body stimulation method according to claim 8, wherein the vibrating of the platform is performed under such a condition that the user hangs the belt on his/her shoulder while the both ends of the belt are connected to the platform.

10. The body stimulation method according to claim 9, wherein the vibrating of the platform is performed by seesawing the platform with a center of the platform between both ends of the platform in the lateral direction as a fulcrum of seesaw so that said both ends move up and down alternately under such a condition that the user gets on the platform, straddling the center of the platform, with the shoulder width direction of the user corresponding to the lateral direction.

11. The body stimulation method according to claim 9, wherein the vibrating of the platform is performed by seesawing the platform with a center of the platform between both ends of the platform in the lateral direction as a fulcrum of seesaw so that said both ends move up and down alternately under such a condition that the user gets on the platform, aligning the both feet, while the both feet are positioned on the center of the platform, orienting the toes of the both feet toward one side in the lateral direction.

12. The vibration device according to claim 2, wherein the length of the belt is adjustable from 1.0 m to 4.0 m.

13. The vibration device according to claim 12, wherein, in a top view of the platform, the platform has a dimension in a lateral direction and a dimension in a perpendicular direction to the lateral direction, wherein the dimension in the lateral direction is not more than 1.1 times the dimension in the perpendicular direction, and
the vibrator vibrates the platform by seesawing the platform with a center of the platform between both ends of the platform in the lateral direction as a fulcrum of seesaw so that said both ends move up and down alternately.

14. The vibration device according to claim 13, wherein the platform has an upper surface and side surfaces connected to the upper surface, wherein the side surfaces include two first side surfaces extending in the lateral direction and two second side surfaces extending in the perpendicular direction, and
the belt has both ends respectively connected to the two second side surfaces.
